(19) United States
(12) Patent Application Publication
(10) Pub. No.: US 2020/0381841 A1
(43) Pub. Date: Dec. 3, 2020

(54) Connector and Antenna System

(71) Applicants: Tyco Electronics (Shanghai) Co. Ltd., Shanghai (CN); TE Connectivity Corporation, Berwyn, PA (US); Tyco Electronics Japan G.K., Kawasaki-shi (JP)

(72) Inventors: Jiahui Chen, Shanghai (CN); Michael Tryson, Middletown, PA (US); Hiroshi Shirai, Kawasaki (JP); Zhiqiang Li, Shanghai (CN); Biaobing Lv, Shanghai (CN)

(73) Assignees: Tyco Electronics (Shanghai) Co. Ltd., Shanghai (CN); TE Connectivity Corporation, Berwyn, PA (US); Tyco Electronics Japan G.K., Kawasaki-shi (JP)

(21) Appl. No.: 16/889,633

(22) Filed: Jun. 1, 2020

(30) Foreign Application Priority Data
Jun. 3, 2019 (CN) 201910476325.X

(51) Int. Cl. H01Q 21/00; H01R 12/71; H01Q 1/48

(52) U.S. Cl. CPC H01Q 21/0006; H01Q 1/48; H01R 12/714

(57) ABSTRACT

A connector for connecting an antenna array includes an insulation body, a plurality of feed terminals on the insulation body electrically contacting a plurality of feed lines of the antenna array, and a plurality of ground terminals on the insulation body electrically contacting a ground layer of the antenna array.

### CROSS-REFERENCE TO RELATED APPLICATION

This application claims the benefit of the filing date under 35 U.S.C. § 119(a)-(d) of Chinese Patent Application No. 201910476325.X, filed on Jun. 3, 2019.

### FIELD OF THE INVENTION

The present invention relates to a connector and, more particularly, to a connector for connecting an antenna array.

### BACKGROUND

In the field of 4G or 5G communication, an antenna system usually comprises an antenna array and a circuit board. In the prior art, the antenna array is usually directly welded to the surface of the circuit board by surface mounting. As a result, in the prior art, the antenna array cannot be separated from the circuit board, which makes it impossible to replace the antenna array or the circuit board separately. For example, if one of antenna patches (also referred to as antenna elements) in the antenna array is failed, the whole antenna system must be replaced, leading to significant waste.

### SUMMARY

A connector for connecting an antenna array includes an insulation body, a plurality of feed terminals on the insulation body electrically contacting a plurality of feed lines of the antenna array, and a plurality of ground terminals on the insulation body electrically contacting a ground layer of the antenna array.

### BRIEF DESCRIPTION OF THE DRAWINGS

The invention will now be described by way of example with reference to the accompanying Figures, of which:

FIG. 1 is a sectional side view of an antenna system according to an embodiment;

FIG. 2 is a plan view of a first surface of an antenna array of the antenna system of FIG. 1;

FIG. 3 is a plan view of a second surface of the antenna array of FIG. 2;

FIG. 4 is a sectional side view of the antenna array of FIG. 2;

FIG. 5 is a plan view of a connector of the antenna system of FIG. 1;

FIG. 6 is a sectional side view of the connector of FIG. 5;

FIG. 7 is a sectional side view of an antenna system according to another embodiment;

FIG. 8 is a sectional side view of a connector of the antenna system of FIG. 7;

FIG. 9 is a perspective view of an antenna system according to another embodiment; and

FIG. 10 is a sectional side view of a connector of the antenna system of FIG. 9.

### DETAILED DESCRIPTION OF THE EMBODIMENT(S)

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

An antenna system according to an embodiment, as shown in FIG. 1, comprises an antenna array 100, a connector 200, and a circuit board 300. The antenna array 100 is configured to be a separate component from the circuit board 300. The connector 200 is adapted to electrically connect the antenna array 100 to the circuit board 300 in a detachable manner. Thereby, in the present disclosure, the antenna array 100 or the circuit board 300 may be replaced separately according to needs, which may save the cost and is very convenient in use.

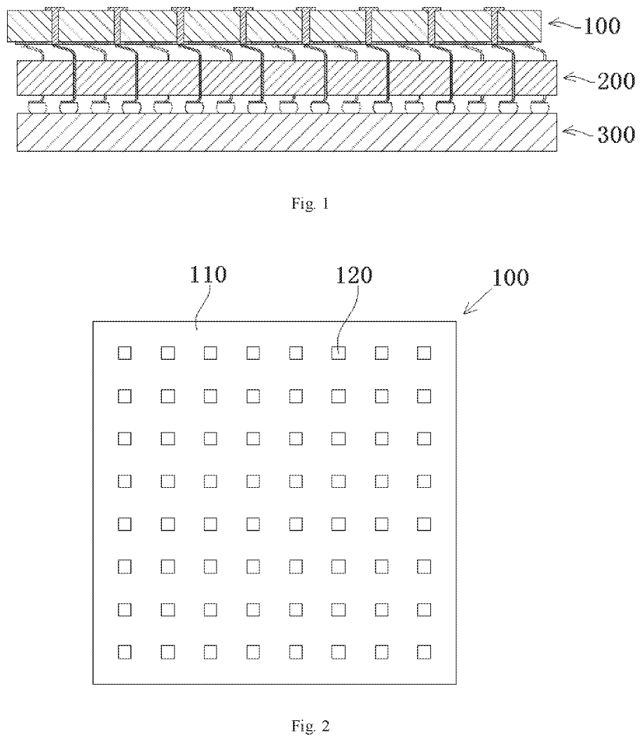

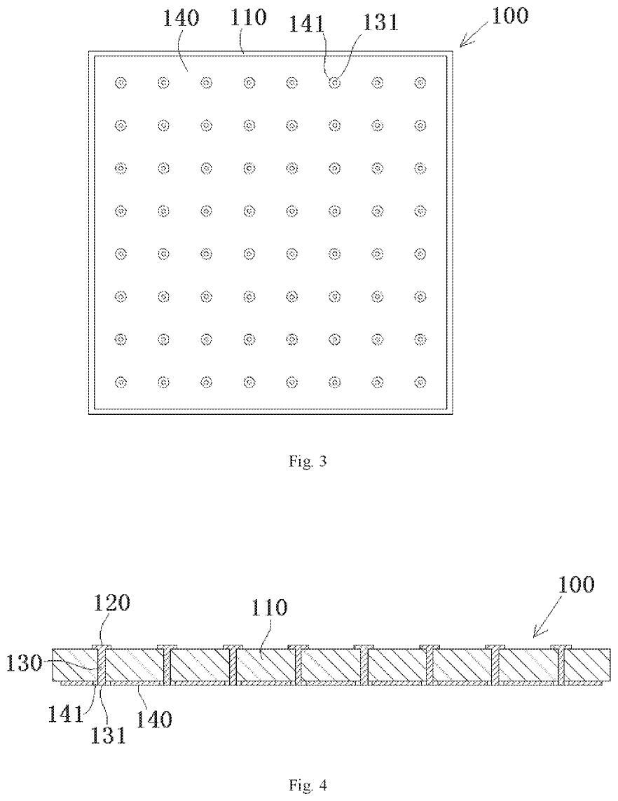

The antenna array 100, as shown in FIGS. 1-4, comprises an insulation substrate 110, a plurality of antenna elements 120, a plurality of feed lines 130, and a ground layer 140. The insulation substrate 110 has a first surface, shown in FIG. 2, and a second surface, shown in FIG. 3, opposite to each other. The plurality of antenna elements 120 are arranged in an array manner on the first surface of the insulation substrate 110, as shown in FIGS. 2 and 4. The plurality of feed lines 130 are provided in the insulation substrate 110 and electrically connected to the plurality of antenna elements 120, respectively. The ground layer 140 is formed on the second surface of the insulation substrate 110, as shown in FIGS. 3 and 4.

As shown in FIGS. 1-4, in an embodiment, the feed line 130 may be a filled via hole or a plated through hole. The filled via hole is generally formed by filling a conductive material in a through hole formed in the insulation substrate 110. The plated through hole is also referred as an electrical interface, which is generally formed by plating a conductive layer to a through hole formed in the insulation substrate 110. As shown in FIGS. 3 and 4, in an embodiment, a plurality of holes 141 are formed on the ground layer 140. The contact ends 131 of the plurality of feed lines 130 are exposed outside through the plurality of holes 141, respectively. The contact ends 131 of the plurality of feed lines 130 are electrically isolated from the ground layer 140 by the respective holes 141. In the illustrated embodiment, the plurality of holes 141 are arranged in an array manner on the ground layer 140.

As shown in FIGS. 2 and 4, in an embodiment, the antenna element 120 is configured to be an antenna patch adapted to be weld on the first surface of the insulation substrate 110 in a surface mounting manner.

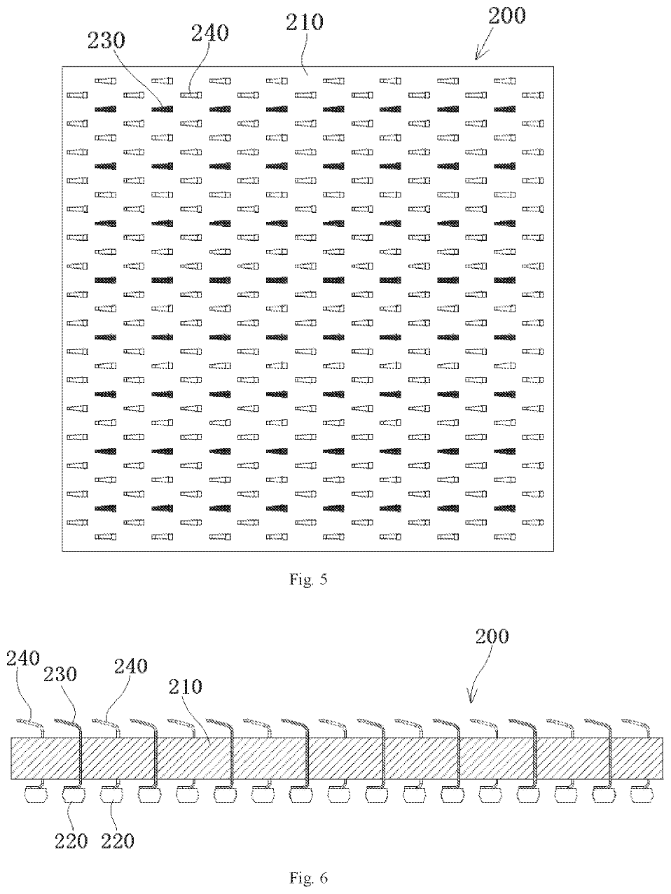

The connector 200, as shown in FIGS. 5 and 6, comprises an insulation body 210, a plurality of feed terminals 230, and a plurality of ground terminals 240. The plurality of feed terminals 230 are provided on the insulation body 210 and configured to electrically contact the feed lines 130 of the antenna array 100, respectively. The plurality of ground terminals 240 are provided on the insulation body 210 and configured to electrically contact the ground layer 140 of the antenna array 100.

As shown in FIGS. 5 and 6, in an embodiment, six ground terminals 240 are arranged around each feed terminal 230, so that each feed terminal 230 is surrounded by six ground terminals 240. In order to distinguish the feed terminal 230 from the ground terminal 240, in the plane view shown in FIG. 5, the feed terminal 230 is represented in black and the ground terminal 240 in white. As shown in FIG. 5, it is clear that each black feed terminal 230 is surrounded by six white ground terminals 240. It should be appreciated for those skilled in this art that the present disclosure is not limited to the illustrated embodiment, for example, there are may be provided two, three, four, five, seven or more ground terminals 240 around each feed terminal 230. That is, each feed terminal 230 may be surrounded by two, three, four, five, seven or more ground terminals 240 around each feed terminal 230.

As shown in FIGS. 5 and 6, in an embodiment, the feed terminals 230 are arranged in an array manner on the insulation body 210 and the ground terminals 240 are arranged in an array manner on the insulation body 210. In an embodiment, the feed terminal 230 is configured to be exactly same as the ground terminal 240, so that the feed terminal 230 and the ground terminal 240 are capable of be used interchangeably. Thereby, it may save the cost.

Each feed terminal 230 has an elastic arm at one end thereof adapted to electrically contact a contact end 131 of the feed line 130, and ground terminal 240 has an elastic arm at one end thereof adapted to electrically contact the ground layer 140. The connector 200, as shown in FIG. 6, includes a plurality of contact pads 220. The plurality of contact pads 220 are connected to the other ends of the feed terminals 230 and the ground terminals 240, respectively. The connector 200 is adapted to electrically contact the circuit board 300 by the plurality of contact pads 220. In an embodiment, the plurality of contact pads 220 may be soldered onto the other ends of the feed terminals 230 and the ground terminals 240, respectively.

As shown in FIGS. 1 and 6, the contact pad 220 may exhibit a columnar shape, a drum shape, a cubic shape, or a spherical shape. Each contact pad 220 has a bottom surface adapted to electrically contact the circuit board 300, and the bottom surfaces of the plurality of contact pads 220 are in a common plane parallel to a surface of the circuit board 300. In this way, the plurality of contact pads 220 may be simultaneously and reliably in electrical contact with the circuit board 300. It should be appreciated for those skilled in this art that the present disclosure is not limited to the embodiments shown in FIG. 1-6. For example, the aforementioned contact pad 220 is not necessary and may be removed.

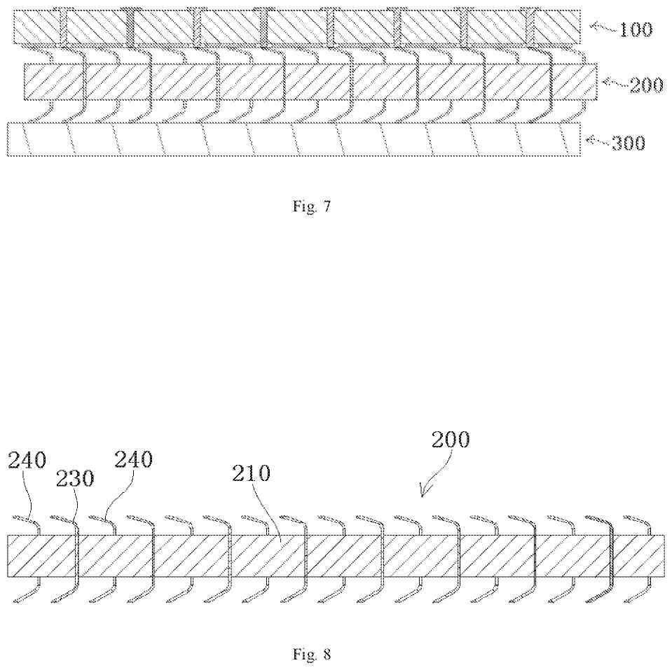

An antenna system according to another embodiment is shown in FIG. 7. A connector 200 of the antenna system shown in FIG. 7 is shown in FIG. 8. As shown in the embodiment of FIGS. 7 and 8, each feed terminal 230 has an elastic arm at the other end thereof adapted to electrically contact the circuit board 300. Each ground terminal 240 has an elastic arm at the other end thereof adapted to electrically contact the circuit board 300. In this case, the aforementioned contact pad 220 is omitted and saved.

In an embodiment, the antenna system may further comprise a pressing mechanism (not shown). The pressing mechanism is adapted to apply a pressure on the first surface of the antenna array 100, so that the feed terminals 230 and the ground terminals 240 of the connector 200 are reliably in electrical contact with the antenna array 100 and the circuit board 300.

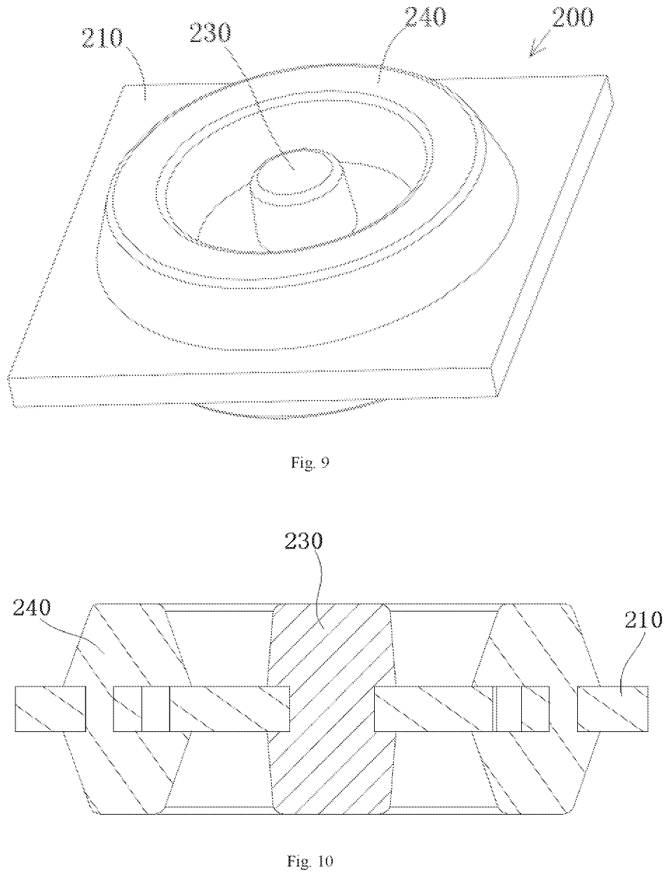

FIG. 9 is an illustrative cross section view of an antenna system according to yet another exemplary embodiment of the present disclosure; FIG. 10 is an illustrative cross section view of a connector of the antenna system shown in FIG. 9.

As shown in FIGS. 9-10, in an embodiment, the feed terminal 230 has a columnar shape, the ground terminal 240 has a cylindrical shape, and each feed terminal 230 is provided in an inner space of the respective ground terminal 240. In an embodiment, each feed terminal 230 has a first circular contact surface at one end thereof adapted to electrically contact a contact end 131 of the feed line 130. Each ground terminal 240 has a first annular contact surface at one end thereof adapted to electrically contact the ground layer 140. Each feed terminal 230 has a second circular contact surface at the other end thereof adapted to electrically contact a circuit board 300. Each ground terminal 240 has a second annular contact surface at the other end thereof adapted to electrically contact the circuit board 300.

In the above various exemplary embodiments of the present disclosure, the antenna array 100 may be electrically connected to a circuit board 300 by a universal connector 200 in a detachable manner. Therefore, the antenna array 100 or the circuit board 300 may be replaced separately according to needs, which may save the cost and is very convenient in use.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle. Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector for connecting an antenna array, comprising:
an insulation body;
a plurality of feed terminals on the insulation body electrically contacting a plurality of feed lines of the antenna array; and
a plurality of ground terminals on the insulation body electrically contacting a ground layer of the antenna array.

2. The connector of claim 1, wherein at least two ground terminals are arranged around each feed terminal, each feed terminal is surrounded by the at least two ground terminals.

3. The connector of claim 1, wherein at least four ground terminals are arranged around each feed terminal, each feed terminal is surrounded by the at least four ground terminals.

4. The connector of claim 1, wherein at least six ground terminals are arranged around each feed terminal, each feed terminal is surrounded by the at least six ground terminals.

5. The connector of claim 1, wherein the feed terminals are arranged in an array manner on the insulation body.

6. The connector of claim 1, wherein the ground terminals are arranged in an array manner on the insulation body.

7. The connector of claim 1, wherein each of the feed terminals is identical to each of the ground terminals and the feed terminals and ground terminals are capable of being used interchangeably.

8. The connector of claim 1, wherein each feed terminal has an elastic arm at one end adapted to electrically contact a contact end of one of the feed lines, and each ground terminal has an elastic arm at one end adapted to electrically contact the ground layer.

9. The connector of claim 8, further comprising a plurality of contact pads connected to an end of each feed terminal opposite the one end and an end of each ground terminal opposite the one end, the contact pads electrically contact a circuit board.

10. The connector of claim 9, wherein each of the contact pads has a columnar shape, a drum shape, a cubic shape, or a spherical shape.

11. The connector of claim 10, wherein each of the contact pads has a bottom surface electrically contacting the circuit board, and the bottom surfaces of the plurality of contact pads are in a common plane parallel to a surface of the circuit board.

12. The connector of claim 8, wherein each feed terminal has another elastic arm at an end opposite the one end adapted to electrically contact a circuit board, and each ground terminal has another elastic arm at an end opposite the one end adapted to electrically contact the circuit board.

13. The connector of claim 1, wherein each of the feed terminals has a columnar shape, each of the ground terminals has a cylindrical shape, and each feed terminal is provided in an inner space of one of the ground terminals.

14. The connector of claim 13, wherein each feed terminal has a first circular contact surface at one end electrically contacting a contact end of one of the feed lines, and each ground terminal has a first annular contact surface at one end electrically contacting the ground layer.

15. The connector of claim 14, wherein each feed terminal has a second circular contact surface at an end opposite the one end electrically contacting a circuit board, and each ground terminal has a second annular contact surface at an end opposite the one end electrically contacting the circuit board.

16. An antenna system, comprising:
a circuit board;
an antenna array separate from the circuit board; and
a connector electrically connecting the antenna array to the circuit board in a detachable manner.

17. The antenna system of claim 16, wherein the antenna array includes:
an insulation substrate having a first surface and a second surface opposite to each other;
a plurality of antenna elements are arranged in an array manner on the first surface of the insulation substrate;
a plurality of feed lines provided in the insulation substrate and electrically connected to the plurality of antenna elements; and
a ground layer formed on the second surface of the insulation substrate, a plurality of holes are formed on the ground layer, a contact end of each of plurality of feed lines is exposed through one of the holes and electrically isolated from the ground layer.

18. The antenna system of claim 17, wherein each of the antenna elements is an antenna patch welded on the first surface of the insulation substrate in a surface mounting manner.

19. The antenna system of claim 17, wherein the connector includes:
an insulation body;
a plurality of feed terminals on the insulation body electrically contacting the contact ends of the feed lines; and
a plurality of ground terminals on the insulation body electrically contacting the ground layer.

20. The antenna system of claim 19, further comprising a pressing mechanism adapted to apply a pressure on the first surface of the antenna array, so that the feed terminals and the ground terminals of the connector electrically contact the antenna array and the circuit board.
